(19) United States
(12) Patent Application Publication
(10) Pub. No.: US 2004/0258315 A1
(43) Pub. Date: Dec. 23, 2004

(54) Image processing system, image forming apparatus, image processing method, program and recording medium

(76) Inventor: Yasuyuki Nomizu, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/797,129

(22) Filed: Mar. 11, 2004

(30) Foreign Application Priority Data
Mar. 12, 2003 (JP) 2003-066583
Jan. 27, 2004 (JP) 2004-018812

(51) Int. Cl. G06K 9/36

(52) U.S. Cl. 382/232

(57) ABSTRACT

A client computer includes a storing part storing a code which is obtained by reversibly compressing and coding an image according to a predetermined coding way having a hierarchy configuration from a reversible part through a non-reversible part; a altering part generating, from the code, a non-reversible code; a transmission part transmitting the either reversible or non-reversible code, or the image obtained from decoding the code, to a predetermined transmission destination; and a selecting part selectively performing transmission of the non-reversible or the reversible code, or the image obtained therefrom.

### BACKGROUND OF THE INVENTION

1. Field of the Invention

The present invention relates to a network system including image processing apparatuses, to an image forming apparatus, to an image processing method, to a program and to a recording medium, for selectively providing reversible or non-reversible image compressed code for effectively processing image data.

2. Description of the Related Art

For example, Japanese laid-open patent application No. 11-144052 discloses an art, according to which, an average thinned-out image or a thinned-out contour image is obtained from a compressed fixed-length, and the image is output.

### SUMMARY OF THE INVENTION

Recently, in a digital image processing apparatus, for the purpose of improving image quality, a tendency occurs in which a resolution in image data is increased or the number of available tone levels therein is increased. However, by such a tendency, the size of information of the image has increased accordingly. For example, when an image having two tone levels (white/black) is converted into an image having 256 tone levels, the size of the information increases 8 times. Increase in the information size 8 times results in an information storage capacity needed for storing the image data increases 8 times accordingly. As a result, the costs of an apparatus which is used for handling such image data increase accordingly. In order to solve this problem, image data compression and coding is performed for the purpose of reducing the required storage capacity.

As a method of compressing and coding image data, there are techniques, through which, a multi-tone-level image is effectively coded. A typical one of these techniques is, for example, a JPEG (Joint Photographic Experts Group) method, for which, a standard has been recommended by ISO and ITU-T, as being well known. In the JPEG method, there are a DCT method which is a basic way and a DPCM method which is an optional one. The DCT method is a so-called non-reversible coding method of lossy coding method in which the information size of an original image is partially reduced to the extent such that the image quality is not substantially degraded with a use of visual characteristics of human beings. The DPCM method is a so-called lossless or reversible method in which no reduction in the information contents of the original image is performed.

According to the DCT method, image information is transformed into frequency information according to a discrete cosine transform (DCT) technique, and then, coding of the information is performed. On the other hand, according to the DPCM method, a target pixel level is predicted with a use of peripheral pixels, and a prediction error is coded. In terms of image quality, the DCT method is preferable having high processing efficiency. However, in terms of storage of information and applicability thereof afterwards, the DPCM method is preferable since the DCT method is a non-reversible method as mentioned above. Ideally, a reversible method with processing high efficiency is desired. However, there is a limit of improving the processing efficiency in the DPCM method in the current situation. Accordingly, the DCT method is mainly used for compressing a multi-tone-level image having a relatively increased number of tone levels with a use of a personal computer (PC) or so. However, in the case of applying the DCT method, a block distortion or a mosquito distortion in a contour part may occur which distortion is unique occurring when the DCT method is applied, in case the compression rate is increased, and thus, the image quality may be remarkably degraded in such a case. Especially for a text image, such a tendency may become remarkable, and thus, a serious problem may occur in terms of image quality.

Furthermore, although the JPEG method is advantageous in terms of effectively reducing the required data storage capacity, it is not necessarily advantageous in a situation in which an image is edited or modified by a user which is printed out afterwards with a use of a digital copier or so. This is because, according to the JPEG method, a spatial position in an image cannot be identified in a coded state. In other words, according to the JPEG method, it is not possible to decode only a desired spatial part of a given coded image. Accordingly, in order to achieve editing or modifying a given coded image, it is necessary to once decode the entire coded image, then, desired editing or modifying is performed on the image thus obtained, and then, if necessary, again coding is performed on the thus-edited or modified decoded image. In such a case, a large data storage capacity is needed for temporarily storing the decoded (i.e., decompressed) image. For example, approximately 100 Mbytes are needed for an RGB color image in A4 size of 600 dpi.

As a measure to solve this problem in terms of memory's storage capacity required in case of editing or modifying a given image, a fixed length coding method may be applied. There are two types in methods of coding an image in terms of a code length obtained through coding. One thereof is a variable-code-length coding method, and the other is a fixed-code-length coding method. The variable-code-length coding method is superior in terms of coding efficiency and reversible property. In contrast thereto, the fixed-code-length coding method is advantageous since a spatial position in a given image can be identified in a coded state. In fact, in the fixed-code-length coding method, it is thus possible to extract only a specific spatial part of the image from the coded image, and reproduce it. This means that it is possible to perform editing/modifying processing on the image in the coded state. However, the fixed-code-length coding method is disadvantageous in an aspect in which the coding efficiency is relatively low in general, and also, reversible coding is difficult.

In order to solve these problems in the JPEG method, a coding method called JPEG 2000, derived from the above-described conventional JPEG method, has been recently taken attention. The method of JPEG 2000 is a transform coding method employing wavelet transform technique, and it is expected that JPEG 2000 will replace the conventional JPEG method in the future in a field of still image processing such as color image processing. According to JPEG 2000, in addition to avoiding image degradation even for a low bit rate zone which degradation may otherwise occur when applying the conventional JPEG, many new practical function are provided. One thereof is a tiling function, by which coding is performed for each tile obtained from spatially dividing a given original image independently, and thus, it becomes possible to identify a spatial position of the image even in a coded state. Thus, it becomes possible to perform editing/modifying a given image in the coded state. However, even according to the JPEG 2000 scheme, a problem may occur in terms of processing speed. As the JPEG 2000 scheme includes many functions and has high performance, the processing becomes complicated. In comparison with the conventional JPEG, approximately 4 times or 5 times of processing time is needed when the processing is executed by means of software. Especially in a case of applying an application prepared for an editing purpose, a serious problem may occur therefrom for a user therefrom.

In order to solve this problem, the following method utilizing the above-mentioned feature of JPEG 2000 may be applied. That is, an image is first compressed and coded reversibly according to JPEG 2000. After that, when the image is displayed via a display screen or so, in which not so high image quality is needed for such a screen display purpose in general, a non-reversible code is produced from the above-mentioned code reversibly compressed and coded, according to JPEG 2000. Then, with a use of thus obtained non-reversible code having the thus-reduced size, the image is displayed. Thereby, since the non-reversible code has the reduced size in comparison to the original reversible code according to JPEG 2000, a storage capacity required can be reduced accordingly, and also, a processing speed can be improved accordingly for displaying the image. On the other hand, in case where the image is printed out in which a relatively increased image quality is needed in general for the purpose of printing out purpose, the original reversible code is used as it is. In this method, a non-reversible code having a reduced data size can be applied in case of an increased image quality is not necessarily required. Accordingly, it is possible to solve the above-mentioned problem of JPEG 2000 which originally requires a long processing time as mentioned above.

In contrast thereto, according to the art disclosed by the above-mentioned Japanese laid-open patent application No. 11-144052 in which an average thinned-out image or a thinned-out contour image is obtained from a fixed-length compressed code, it is difficult to achieve reversible coding processing because of the fixed length coding.

Furthermore, Japanese laid-open patent application No. 11-144052 does not disclose a scheme in which a reversible code is produced from an original image and the image data is provided selectively in a non-reversible code which is produced from the previously produced reversible code in one case or in the original reversible code in another case according to a specific particular purpose for a predetermined destination which then uses the thus-provided image data.

An object of the present invention is to achieve a configuration/scheme in which, an image is compressed and coded according to a coding way such as that of JPEG 2000, in which reversible coding can be easily performed, and also, a code thus produced can be easily processed or transmitted at a high speed, with saving a required data storage capacity.

According to the present invention, a storing part storing a code which is obtained by reversibly compressing and coding an image according to a predetermined coding way having a hierarchy configuration from a reversible part through a non-reversible part; a altering part generating, from the code, a non-reversible code; a transmission part transmitting the either reversible or non-reversible code, or image data obtained from decoding the code, to a predetermined transmission destination; and a selecting part selectively performing transmission of the image data in the non-reversible code or in the reversible code thus obtained are provided.

By applying the coding way having a hierarchy configuration from a reversible part through a non-reversible part, it is easy to produce a reversible code. Furthermore, such a coding way may provide a reversible code and a non-reversible code from a common original image at the same time. Furthermore, a reversible code or image is provided in case where a high image quality is needed, while a non-reversible code is provided in case where such a high image quality is not necessarily needed, as mentioned above. As a result, it is possible to effectively improve the processing speed in data processing or data transmission between related parts/devices and also to reduce the required data storage capacity especially in a case where the non-reversible code obtained therefrom is used.

As the above-mentioned coding way having a hierarchy configuration from a reversible part through a non-reversible part, the above-mentioned method according to JPEG 2000 is preferably applied.

Thus, according to the present invention, a reversible code or image is selected to be used in a case where a high image quality is needed, while, it is also possible to select a non-reversible code or image and use it in case where the image is displayed on a display device and an operation is performed for editing or modifying the image data with a use thereof. As a result, as mentioned above, it is possible to effectively improve the processing speed in the data processing or data transmission to the display device and also to reduce the required data storage capacity especially in a case where the non-reversible code or image is used. On the other hand, it is also possible to use even the reversible code or image for a case where a high image quality is needed, for example, for a printing-out purpose. Thus, it is possible to provide a high definition printed-out image in this case.

Further, according to the present invention, the selecting part may transmit the reversible code having information indicating the contents of operation of editing or modifying the image data attached thereto. Thereby, in the transmission destination, for example, in a server apparatus, the contents of operation of editing or modifying the image data may be actually reflected onto the original image data in the reversible code according to the attached information. Accordingly, in a case where, even when instructions for operation of editing/modifying the image data are input in a client apparatus, it is determined that actual reflection of these contents of editing/modifying operation onto the original image data should be executed by a certain external another apparatus such as the server apparatus, and then, it is possible that the certain external other apparatus can be made to execute actual reflection of the contents of operation of editing/modifying the image data with the transmitted image data and instruction information.

Furthermore, according to the present invention, the client apparatus may determine whether the contents of operation of editing or modifying for the image data are actually reflected on the image data by the own apparatus or by another external apparatus. Then, when it is determined that the actual reflecting operation of the contents of editing/modifying should be executed by the own apparatus, this reflecting operation is performed by the client apparatus by itself. On the other hand, when it is determined that the actual reflecting operation of the contents of editing/modifying should be executed by another certain external apparatus, this reflecting operation is performed by the other certain external apparatus such as the server apparatus according to the information indicating the contents of editing/modifying which is transmitted from the client apparatus together with the reversible code or image to be thus processed.

Thus, according to the present invention, in case where a high image quality is not necessarily needed, for example, for the purpose of displaying the image on the display device or so for the purpose of editing or modifying the image with a use of the display of the image, the non-reversible code or image should be used for this purpose. Accordingly, required processing for this purpose, data transmission to the display device or so can be made at an increased processing speed, and also, the required data storage capacity can be effectively reduced.

### BRIEF DESCRIPTION OF THE DRAWINGS

Other objects and further features of the present invention will become more apparent from the following detailed description when read in conjunction with the accompanying drawings:

FIG. 1 shows an entire configuration of a network system according to one embodiment of the present invention;

FIG. 2 shows a block diagram illustrating an electrical connection in a digital copier included in the network system shown in FIG. 1;

FIG. 3 shows a block diagram illustrating an electrical connection in each of a server computer and a client computer included in the network system shown in FIG. 1;

FIG. 4 illustrates processing in a first specific example performed in the embodiment shown in FIG. 1;

FIG. 5 shows an operation flow chart of operation performed by the client computer according to the first specific example shown in FIG. 4;

FIGS. 6A and 6B illustrate memory maps in the client computer according to the first specific example shown in FIG. 4;

FIG. 7 illustrates processing in a second specific example performed in the embodiment shown in FIG. 1;

FIG. 8 shows an operation flow chart of operation performed by the client computer according to the second specific example shown in FIG. 7;

FIG. 9 shows a communication sequence according to the second specific example shown in FIG. 7;

FIG. 10 illustrates a memory map in the client computer according to the second specific example shown in FIG. 7;

FIG. 11 illustrates processing in a third specific example performed in the embodiment shown in FIG. 1;

FIG. 12 shows an operation flow chart of operation performed by the client computer according to the third specific example shown in FIG. 11;

FIG. 13 shows a communication sequence according to the third specific example shown in FIG. 11;

FIG. 14 illustrates a memory map in the client computer according to the third specific example shown in FIG. 11;

FIG. 15 illustrates processing in a fourth specific example performed in the embodiment shown in FIG. 1;

FIG. 16 shows an operation flow chart of operation performed by the client computer according to the fourth specific example shown in FIG. 15;

FIG. 17 shows an operation flow chart of operation performed by the server computer according to the fourth specific example shown in FIG. 15;

FIG. 18 shows a communication sequence according to the fourth specific example shown in FIG. 15;

FIG. 19 illustrates a memory map in the client computer according to the fourth specific example shown in FIG. 15;

FIG. 20 illustrates a specific example of a configuration of a table used for load sharing processing according to the embodiment of the present invention;

FIG. 21 illustrates a specific example of a screen display in case the load sharing processing is executed according to the embodiment of the present invention;

FIG. 22 illustrates a configuration example in which other network resources are applied in the embodiment of the present invention;

FIG. 23 shows an operation flow chart of operation performed by a digital copier according to another embodiment of the present invention; and

FIG. 24 shows another operation flow chart of operation performed by the digital copier according to the other embodiment of the present invention.

### DETAILED DESCRIPTION OF THE PREFERRED EMBODIMENTS

A first embodiment of the present invention will now be described.

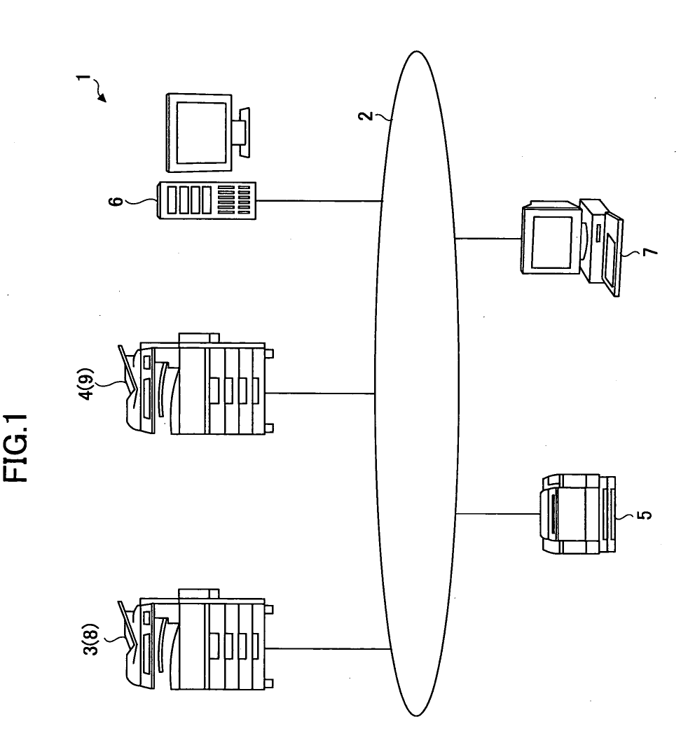

FIG. 1 shows a general block configuration of a network system 1 in the first embodiment of the present invention. As shown, in the network system 1, a communication network 2 such as a local area network has various types of apparatuses such as composite machines 3 and 4, a printer 5, a server computer 6, a client computer 7, and so forth, connected thereto. In this embodiment, the two composite machines 3 and 4 are included. However, a scanner may be applied instead of the composite machine 3, and a printer may be applied instead of the composite machine 4. In other words, the composite machine 3 should have a scanning function of reading in an original image, while the composite machine 4 should have a printing function of performing image formation onto a medium such as a paper based on given image data. Hereinafter, the composite machine 3 may be referred to as a scanner 8 while the composite machine 4 may be referred to as a printer 9.

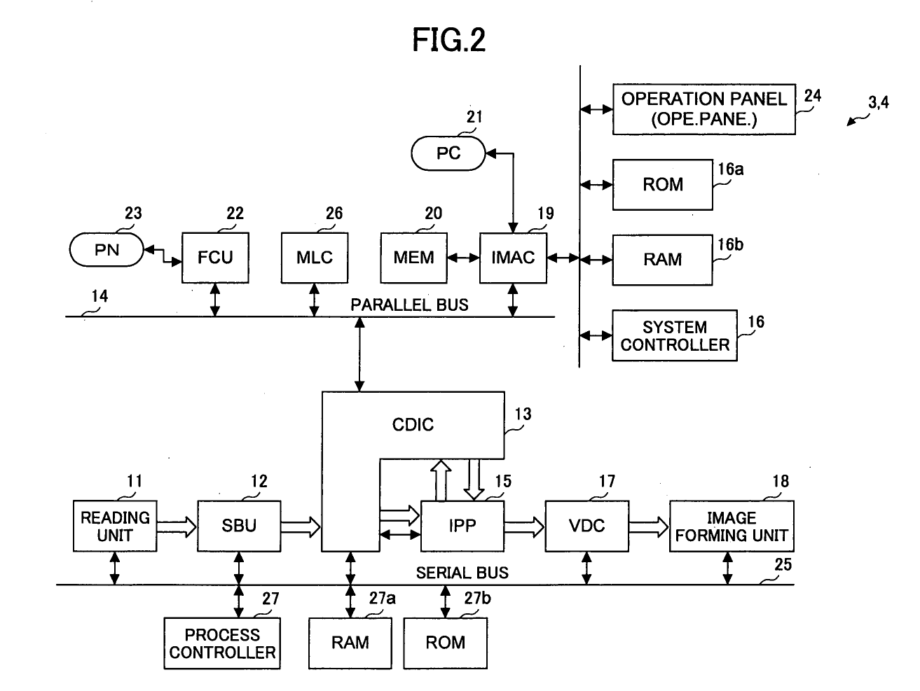

FIG. 2 shows an electrical connection in each of the composite machines 3 and 4. The composite machine 3/4 includes a reading unit 11 which is a scanner reading an original optically. In this reading unit 11, reflected light obtained from applying light onto the original by a lamp or so is focused onto a photo-electric converting device such as a CCD (charge coupled device) via an optical system including mirrors and lenses. This photoelectric converting device is mounted in an SBU (sensor board unit) 12, and an image signal (electric signal) obtained from the photoelectric converting device is converted into a digital signal there, and then, is output from the SBU 12. The digital image signal thus output is provided to a CDIC (compression/decompression and data interface control part) 13. The CDIC 13 controls all the data transfer of image data between functional devices and a data bus in the machine. The CDIC 13 performs data transfer among the SBU 12, a parallel bus 14 and an IPP (image processing processor) 15, and performs communications between a system controller (CPU) 16 which performs the entire control of the system) and a process controller 27 provided for image data. RAM 16A and ROM 16B are also connected to the parallel bus 14. The image signal from the SBU 12 is transferred to the IPP 15 via the CDIC 13, where signal degradation (assumed as being signal degradation in the scanner system) occurring in the optical system and occurring due to the quantization into the digital signal is corrected, and then, is output to the CDIC 13 again.

The composite machine 3/4 performs a job of re-using an image once read in by the reading unit 11 and stored in a memory and a job of not storing read image in the memory. These jobs will now be described separately. As an example of the job of storing the read image in the memory, when one page of image is copied for a plurality of copies, original reading operation is performed only once by the reading unit 11, the thus-read-in image is stored in the memory, and then, the thus-stored image data is read out a plurality of times therefrom for performing the copying operation for providing the plurality of copies. As an example of the above-mentioned job of not using the memory, a single original is copied once, and in this case, since the read-in image is printed out as it is, no memory access operation is needed.

In the above-mentioned case of not using the memory, image data transferred to the CDIC 13 from the IPP 15 is returned to the IPP 15 from the CDIC 13. In the IPP 15, image quality processing is performed for the purpose of converting brightness data from the photoelectric converting device into area-tone data. The image data thus obtained from the image quality processing is transferred to a VDC (video data control unit) 17 from the IPP 15. Then, post processing concerning dot allocation and pulse control processing for reproducing image dots is performed on the signal of area-tone data. Then, with the thus-obtained signal, a reproduced image is formed on a transfer paper by means of an image forming unit 18 which is a printer engine for forming an image in an electrophotographic technology. Other than the electrophotographic technology, various types of techniques such as an ink-jet technique, a sublimatic thermal transfer technique, a direct thermal transfer technique, a fusion thermal transfer technique, or so may be applied as the printing method in the image forming unit 18.

A flow of image data in the above-mentioned case of storing image data in the memory, and performing additional processing such as rotation of the image orientation, combining of images, or so, for example, performed when reading the stored image will now be described. In this case, image data transferred to the CDIC 13 from the IPP 15 is sent to an IMAC (image memory access control unit) 19 via the CDIC 13 and the parallel bus 14. In the IMAC 19, under control by the system controller 16, access control operation for an MEM (memory module) 20 which is a storage device for image data, development of printing data for an external personal computer 21 and compression/decompression of image data for the purpose of effectively utilizing the MEM 20 are performed. The image data sent to the IMAC 19 is stored in the MEM 20 after being compressed, and the data thus stored is read out as is necessary. The image data thus read out is returned into the original image data through decompression, and then, is returned to the CDIC 13 via the parallel bus.

After being transferred to the IPP 15 from the CDIC 13, the image data has image quality processing and pulse control processing performed thereon by the VDC 17, and then, according to the thus-obtained image data, an image is formed on a transfer paper by means of the image forming unit 18.

The composite machine 3/4 also has a facsimile transmission function. This function is to perform image processing on the read-in image data by the IPP 15, and then transfer it to an FCU (facsimile control unit) 22 via the CDIC 13 and the parallel bus 14. In the FCU 22, data transform is performed on the given image data for transmitting it through a communication network, and then, the thus-obtained image data is transmitted out as facsimile data to a PN (public circuit) 23. As to facsimile reception, circuit data received from the PN 23 is transformed into image data by the FCU 22, and is transferred to the IPP 15 via the parallel bus 14 and the CDIC 13. In this case, no special image processing is performed, but dot re-allocation processing and pulse control processing are performed by the VDC 17, and then, a reproduced image is formed on a transfer paper by the image forming unit 18.

In a situation in which a plurality of jobs such as copying processing, facsimile transmission/reception processing and printing-out processing are performed in parallel, the system controller 16 and process controller 27 perform arbitration control for allocating usage rights for respective resources such as the reading unit, the image forming unit and the parallel bus 14 for the respective jobs.

The process controller (CPU) 27 controls flow of image data, while the system controller 16 controls the entire system and manages starting of the respective resources. A ROM 27A and a RAM 27B are used by the process controller 27.

By operating an operation panel 24 appropriately, a user selects one of the varieties of functions of the composite machine 3/4, and sets the particular contents of processing to be performed by the machine such as copying processing, facsimile processing or so.

The system controller 16 and the process controller 27 make mutual communications therebetween via the parallel bus 14, the CDIC 13 and the serial bus 25. In this case, in the CDIC 13, data format conversion processing is performed for the respective interfaces of the parallel bus 14 and the serial bus 25.

An MLC (media link controller) 26 performs a function of code transform for image data. Specifically, coding of image data, decoding of a code sequence obtained from the coding, and conversion between different coding systems (for example, conversion between the coding system specially provided for the composite machine 3/4 applied by the IMAC 19 and another coding system such as that according to a standard of JPEG 2000) are performed.

A hardware configuration of the printer 5 shown in FIG. 1 is same as that described for the composite machines 3 and 4 with reference to FIG. 2 except that the printer 5 does not include the reading unit 11, the SBU 12 and so forth.

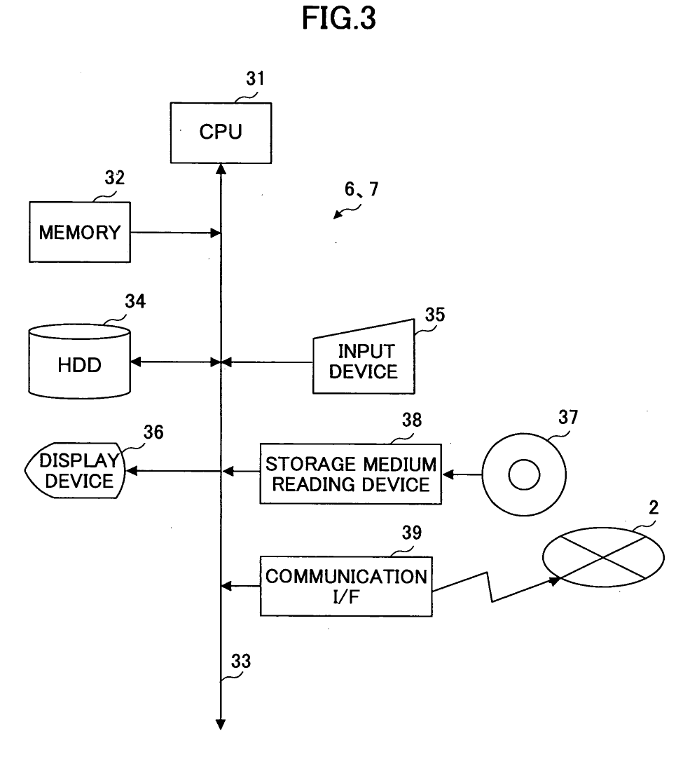

FIG. 3 shows a block diagram illustrating an electrical connection in each of the server computer 6 and the client computer 7. The server computer 6 is a personal computer, a work station or so, while the client computer 7 is a personal computer or so. As shown in FIG. 3, each of the server computer 6 and the client computer 7 includes a CPU 31 performing varieties of operations, and also totally controlling respective parts/components of the computer itself, and memories 32 such as varieties of ROMs and RAMs, which are connected mutually via a bus 33.

Also, to the bus 33, via predetermined interfaces, a magnetic storage device 34 such as a hard disk drive, an input device 35 such as a keyboard, a mouse or so, a display device 36 such as an LCD, a CRT or so, and a storage medium reading device 38 reading from a storage medium 37 such as an optical disk are connected. Further, a predetermined communication interface 39 for performing communications with the communication network 2 is also connected. The communication interface 39 can be connected with a WAN such as the Internet via the network 2. As the above-mentioned storage medium, varieties of media such as an optical disk such as a CD or a DVD, a magneto-optical disk, a flexible disk, or so may be applied. The storage medium reading device 38 is, specifically, an optical disk drive, a magneto-optical disk drive, a flexible disk drive or so applied according to the type of the storage medium 37 applied.

In the magnetic storage device 34, an image processing program for causing the computer to execute the present invention is stored. This image processing program is read in from the storage medium 37 acting as a computer readable information recording medium according to the present invention through the storage medium reading device 38, is downloaded therein through the WAN such as the Internet, or so, and then, is installed in the magnetic storage device 34. After that, the server computer 6 or the client computer 7 enters a state in which it can perform by operation the following processing. This image processing program may be one which operates on a predetermined OS. Further, the image processing program may act as a part of specific application software.

In the above-described network system 1 shown in FIG. 1, the scanner 8, the printer 9, the server computer 6, the client computer 7 and so forth handle a code obtained from compressing and coding a given image or handle an image which is obtained from decoding the code in a manner as will be described. The code handled there is a reversible or non-reversible code obtained from compressing and coding according to a well-known algorithm of JPEG 2000. However, a coding method according to the present invention is not limited to that of JPEG 2000, and other various coding methods may be applied as long as they are coding method having a hierarchical configuration from a reversible level part through a non-reversible level part as mentioned above. For example, instead of JPEG 2000, a JBIG method may be applied.

For example, in the case of JPEG 2000, through a well-known wavelet transform process-in a standard JPEG 2000 coding scheme, subband coefficients in respective decomposition levels are obtained. Therefrom, both a reversible code and various forms of non-reversible codes are available as well known, for example. Such a configuration of coding manner is referred to as a coding manner having a hierarchical configured]ion from a reversible part through a non-reversible part, for example.

A plurality of specific examples of processing which are performed in the above-mentioned network system 1 in the first embodiment of the present invention will now be described one by one.

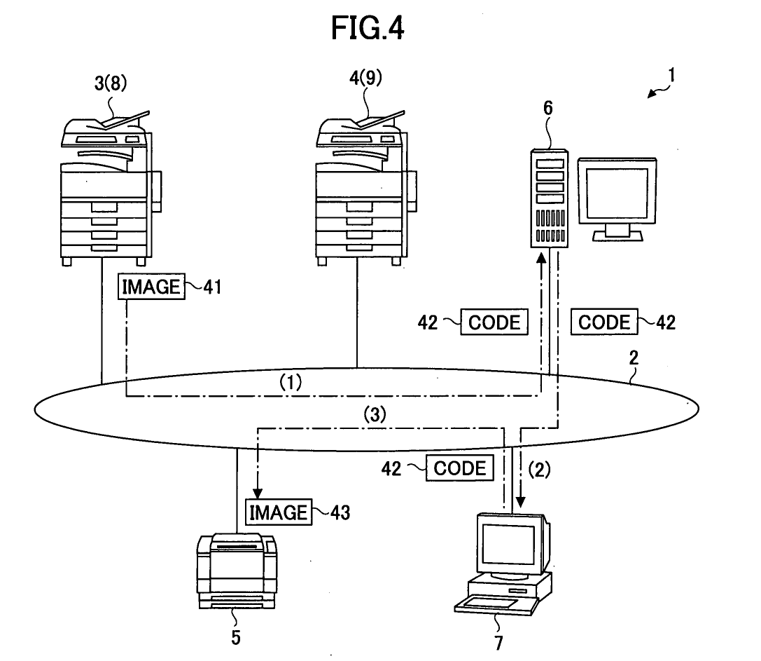

A first specific example will now be described. FIG. 4 illustrates a data flow in the network system 1. First, a user causes the scanner 8 to read in an original image 41, the thus-read image 41 is compressed and coded in a reversible mode according to JPEG 2000 so that the image quality is maintained in the original highest level. Then, the thus-obtained reversible code 42 is once stored in the memory module 20. The code 42 is then transmitted to the server computer 6 (arrow (1)) via the network 2, is stored in the magnetic storage device 34 of the server computer 6, and is managed there. In the server computer 6, the code 42 received is stored in the magnetic storage device 34 together with related information such as detailed information of the input device applied (the scanner 8 in this case), the coding method applied, the image size, the resolution of the image and so forth.

A user who operates the client computer 7 accesses the server computer 6 via the client computer 7, finds the desired image of the code 42 from among image data stored in the server computer 6, and then, in order to perform a desired editing or modifying operation onto the image in the code 42, the user causes the JPEG 2000 code 42 to be transferred to the own apparatus (client computer 7) (arrow (2)). In order to find out the desired image as mentioned above, the user for example should receive a thumbnail image list of image data stored in the server computer 6, and then, select the desired one therefrom. In the client computer 7, the user then performs the desired editing or modifying operation for the received code 42.

The above-mentioned editing or modifying operation may include, for example, an editing operation of changing the size of the given image, adding a display of a page number thereto or so, or a modifying operation of various image processing to the given image. After undergoing the above-mentioned editing/modifying operation, the relevant image data in the code 42 is transmitted to the printer 5, in which the corresponding image 43 is then printed out (arrow (3)) according to a request by the user.

FIG. 5 shows a flow chart illustrating processing performed by the client computer 7 acting as an image forming apparatus in the present first specific example. This processing is performed by the CPU 31 based on the image processing program described above. First, the CPU 3 in the client computer 7 selects the reversible code 42 in JPEG 2000 from the server computer 6 via the communication interface 39 according to the operation input by the user in the client computer, then, the code 42 is sent from the server computer 6 to the client computer 7 and is stored in the magnetic storage device 34 there (storing step). After that, the user can execute the predetermined editing/modifying operation on the image in the code 42 thus stored in the magnetic storage device 34 after designating the code 42 from the storage device 34 (Yes in Step s1). Specifically, when the user operates the input device 35 and selects execution of editing/modifying operation for the code 42 (Yes in Step S2) (selecting step), the reversible code 42 in JPEG 2000 is transformed into a non-reversible code in JPEG 2000 (altering step) suitable to be displayed on the display device 36 in the client computer. After that, the thus-obtained non-reversible code is decoded in Step S3. The thus-obtained non-reversible image 52 is transmitted to the display device 36 (transmitting step), is then displayed in Step S4, and then, the user uses the thus-displayed image for performing the predetermined editing/modifying operation thereon in Step S5. The predetermined editing/modifying operation may include, as mentioned above, an operation of changing the image size, adding a display of a page number or so, for example. The contents of the operation thus performed by the user for the image are once stored in the memory 32 (RAM). After the predetermined editing/modifying operation by the user is completed, the contents of the editing/modifying operation once stored in the memory 32 should be reflected on the image data in the original reversible code 42 (editing/modifying step) in Step S7. Specifically, in Step S7, one of the following two methods may be applied for this purpose: A first method is to decode the entire reversible code 42 in JPEG 2000, and after that, the contents of the editing/modifying operation are reflected on the thus-obtained image. Then, after that, if necessary, the thus-obtained image is again coded in the reversible mode in JPEG 2000. A second method is to decode the reversible code 42 only for a partial image part which should reflect the relevant contents of editing/modifying operation, the contents of editing/modifying operation are reflected on the thus-obtained image part, and then, the thus-obtained image part is again coded in the reversible mode of JPEG 2000.

Then, when the user selects printing out of the relevant image (Yes in Step S8) after the operation of reflecting the contents of editing/modifying operation on the image, or without performing any such reflecting operation, the JPEG 2000 code 42 or the image obtained from decoding this code 42 is transmitted to the printer 5 in Step S9 (transmitting step), and then, the corresponding image is printed out there.

When the user selects finish of the series of operations (Yes in Step S10), the processing is finished. In the other case (No in Step S10), the processing is returned to Step S2.

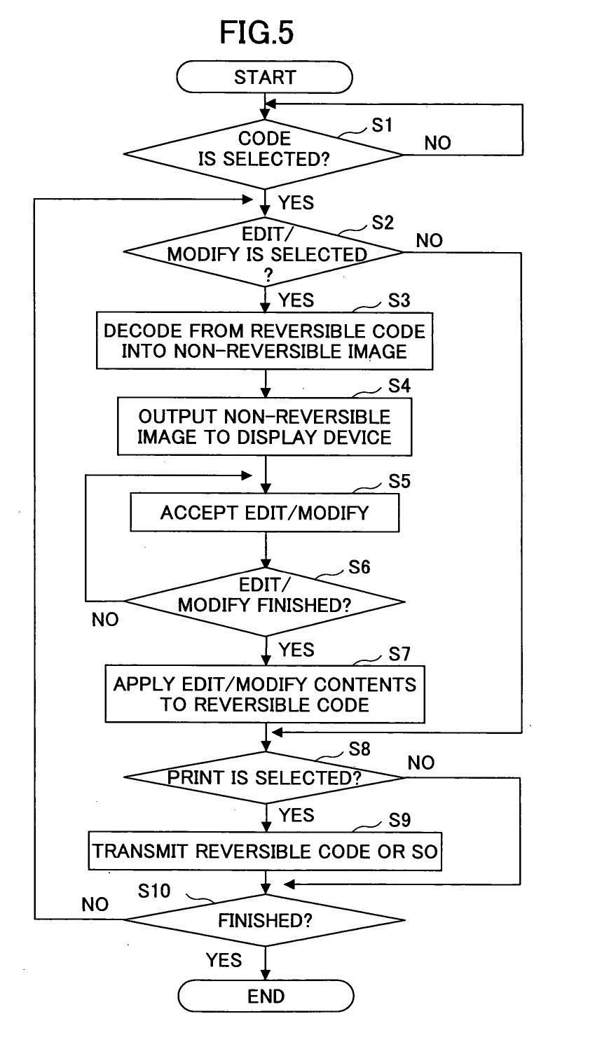

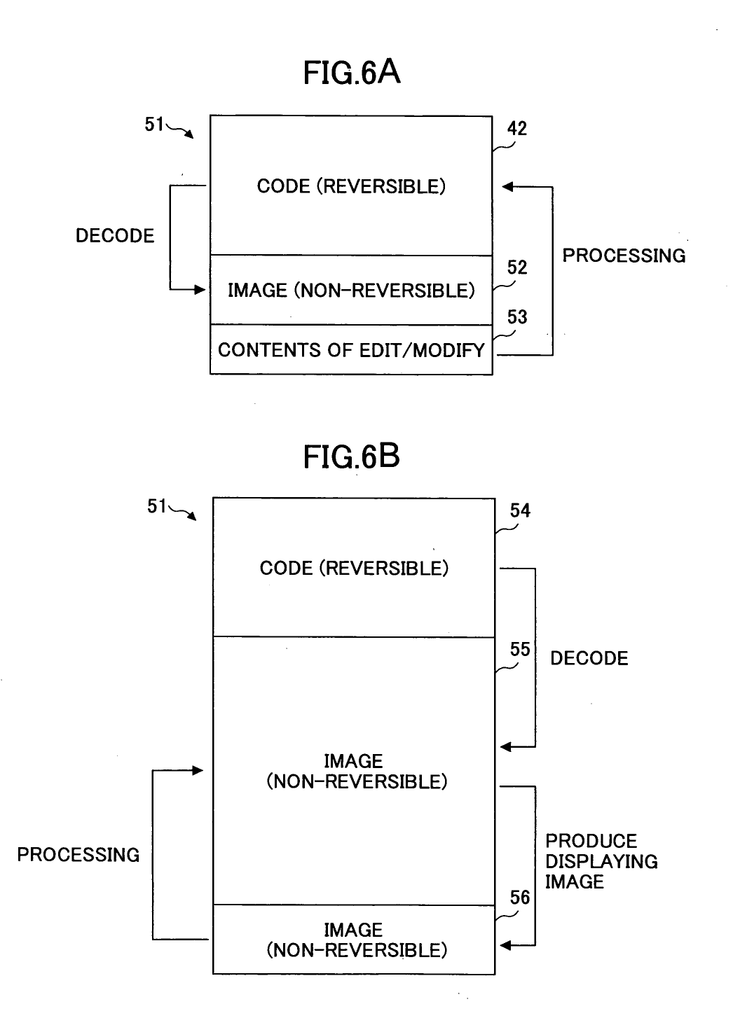

FIGS. 6A and 6B illustrate memory maps in the memory 32 (RAM) in a comparative manner between a case (6A) where the processing described with reference to FIG. 5 is performed according to the present invention and a comparative case (6B) where the conventional JPEG scheme is applied. As shown in FIG. 6A, when the processing in FIG. 5 is performed, in the memory space 51, other than the reversible code 42, the non-reversible image 52 obtained from decoding the code 42 for the purpose of displaying the relevant image on the display device 36 and information 53 indicating the contents of the editing/modifying operation performed by the user in Step S5 described above are stored. The non-reversible image 52 is obtained from the non-reversible code which is obtained from the reversible code 42. In other words, according to the well-known coding method in JPEG 2000, the non-reversible code is obtained as a part of the reversible code 42. As described above, according to the information 53 indicating the contents of the editing/modifying operation, the reversible code 41 is processed in Step S7 so that the contents of editing/modifying operation are reflected thereon.

On the other hand, in the comparison example shown in FIG. 6B, in the memory space 51, a reversible code 54 according to conventional JPEG, a reversible image 55 obtained from decoding the reversible code 54, and a non-reversible image 56 produced from the image 55 for the purpose of displaying on the display device 36 are stored. Then, based on the non-reversible image 56, editing/modifying operation is reflected on the reversible image 55 in this case. With comparison between FIGS. 6A and 6B, it can be seen that, according to the embodiment of the present invention, it is possible to display an image on the display device 36 and to execute editing/modifying operation on an image with an effectively reduced memory capacity as shown.

As a method of obtaining the non-reversible code from the reversible code according to the JPEG 2000 manner, a 2LL subband on a decomposition level 2, a 3LL subband on a decomposition level 3 or so, obtained through wavelet transform according to the standard JPEG 2000 scheme, may be utilized, for example.

Thus, in the client computer 7, in order to perform display of the image on the display device 36 and editing/modifying operation on the image are performed based on the JPEG 2000 reversible code 42, a non-reversible code is generated from the reversible code, and then, the editing/modifying operation is performed with the use of the image in the non-reversible code. Thereby, it is possible to effectively reduce the required memory capacity, and also, to improve the processing speed accordingly. Furthermore, even in a case where a high image quality is needed, for example, in a case of printing out of the resulting image by the printer 5, the original reversible code can be used for this purpose after the relevant editing/modifying is reflected thereon. Accordingly, it is possible to even achieve a high image quality in the thus-printed out image.

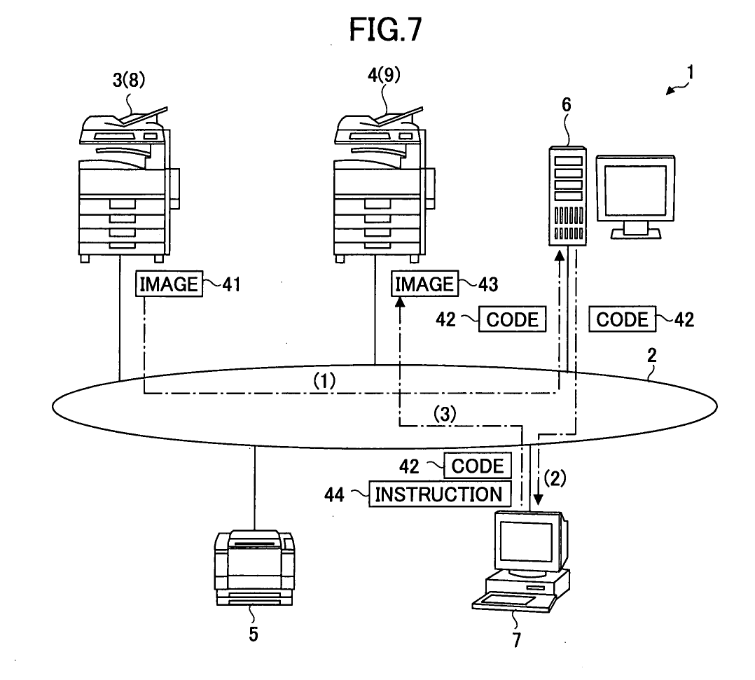

A second specific example in processing performed in the network system 1 according to the first embodiment of the present invention will now be described. FIG. 7 illustrates a data flow in the second specific example in the network system 1. As to processing of arrows (1) and (2) shown in FIG. 7, the processing is same as the processing of arrows (1) and (2) described above with reference to FIG. 4.

After that, in the client computer 7, a desired editing/modifying operation will be performed on the reversible code 42 received from the server computer 6. At this time, considering that the code 41 will be printed out by the printer 9 after the relevant image undergoing the editing/modifying operation, it is determined whether the actual operation of actually reflecting the contents of the editing/modifying operation (performed by a user of the client computer 6) onto the reversible code 42 is executed in the own apparatus (client computer 7) or in the printer 9 instead. The printer 9 is the composite machine 4 as mentioned above, and the composite machine 4 may be regarded as a special apparatus for executing image processing in general. Accordingly, when the printer 9 has no other job at the present time, it may be effective that the above-mentioned operation of actually reflecting the contents of the editing/modifying operation should be executed by the printer 9 instead of the client computer. Then, when it is determined that the above-mentioned operation of actually reflecting the contents of the editing/modifying operation should be executed by the printer 9, the reversible code 42 to be processed and instructions 44 indicating the contents of the editing/modifying operation are output to the printer 9 (arrow (3)) from the client computer. In the printer 9, the image in the reversible code 42 thus received is processed according to the instructions also thus received, i.e., the code 42 is made to reflect the contents of the editing/modifying operation, and after that, the corresponding image is printed out according to the thus-processed code 42 therein.

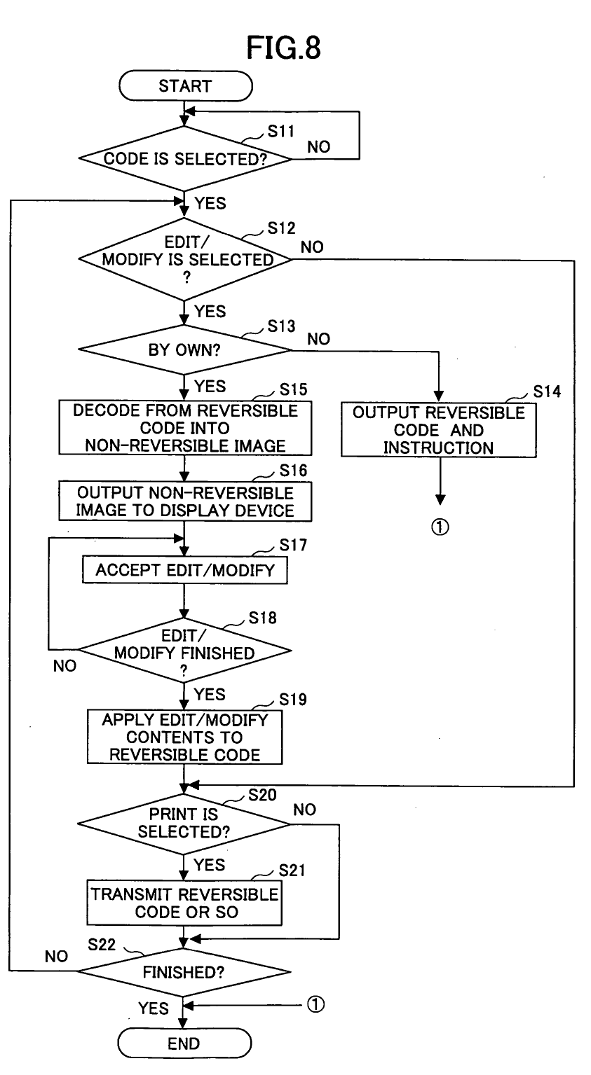

FIG. 8 shows an operation flow chart performed in the client computer 7 which acts as an image forming apparatus in this case. This processing is performed based on the above-mentioned image processing program by the CPU 31. First, the CPU 31 in the client computer 7 selects the reversible code 42 in JPEG 2000 from the server computer 6 via the communication interface 39, and then, the code 42 is sent from the server computer 6 to the client computer 7 and is stored in the magnetic storage device 34 (storing step) same as in the above-mentioned first specific example. After that, the user can execute a predetermined editing/modifying operation on the image in the form of the code 42 thus stored in the magnetic storage device 34 after selecting the code 42 from the storage device 34 (Yes in Step S11). Specifically, when the user operates the input device 35 and selects execution of editing/modifying operation on the code 42 (Yes in Step S12) (selecting step), and also, the user operates the input device 35 and selects ‘processing in the own apparatus (client computer 6’ (Yes in Step S13), processing in Steps S15 through S22 is performed. Since the processing in Steps S15 through S22 is same as the processing S3 through S10 described above with reference to FIG. 5, the duplicated description is omitted. On the other hand, when the user operates the input device 35 and selects execution of final editing/modifying operation on the code 42 (Yes in Step S12) (selecting step), and the user does not select ‘processing in the own apparatus (client computer 6’ (No in Step S13), the reversible code 42 in JPEG 2000 is output to the printer 9 together with the instructions 44 indicating the contents of the editing/modifying operation which will then be performed by the user on the client computer 7, in Step S14.

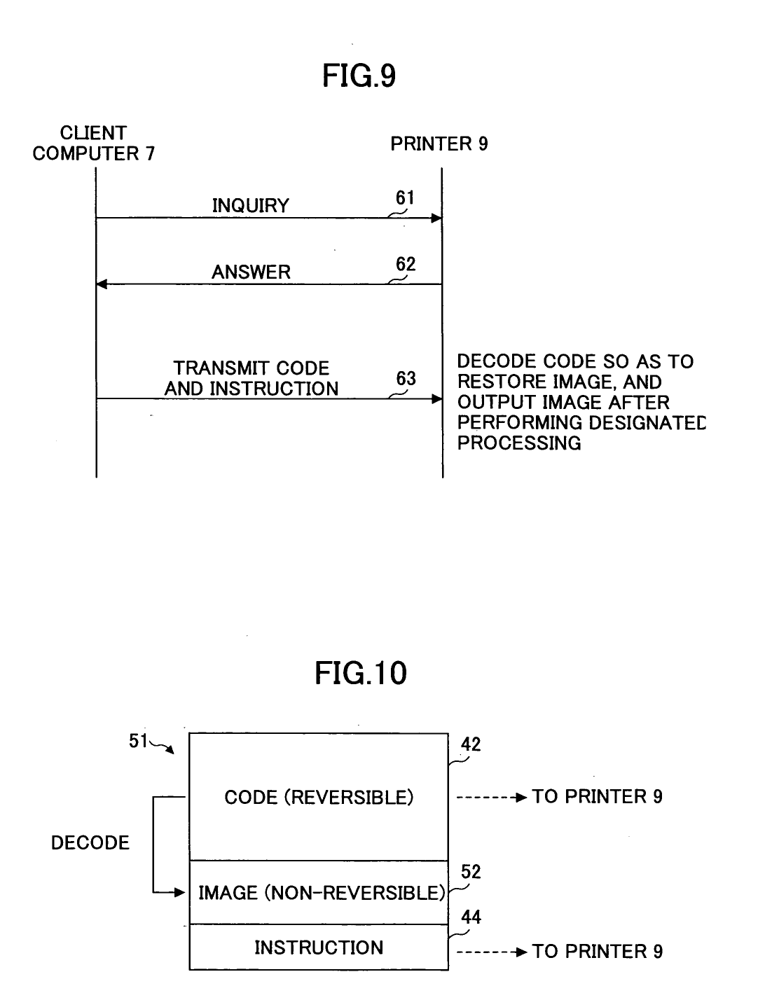

FIG. 9 shows a communication sequence illustrating specific communications performed between the client computer 7 and the printer 9 when Step S14 is performed. First, when the user of the client computer 7 selects ‘actual editing/modifying (actual reflection of the contents of the ex-give editing/modifying operation) in the printer 9’ (No in Step S13 in FIG. 8), the client computer 7 inquires the printer 9 as to whether or not the printer 9 is of a type configured to execute such an actual reflectance of given editing/modifying operation, in an arrow 61. After that, the printer 9 responds thereto, and the client computer 7 receives this response in an arrow 62. When the response indicates that the printer is of a type configured to execute the reflectance operation, the client computer 7 outputs the reversible code 42 in JPEG 2000 as well as the instructions 44 which are information indicating the contents of editing/modifying operation given by the operator therefor on the client computer 7, in an arrow 63. Then, in the printer 9, the code 42 is decoded into the corresponding original image, which is then processed according to the instructions 44, i.e., the given editing/modifying operation contents are reflected on the image. The image thus processed is printed out from the printer 9. On the other hand, when the response to the client computer 7 from the printer 9 in the arrow 62 indicates that the printer 9 is not of a type configured to executed such a reflectance operation, the client computer 7 by itself should execute the relevant operation of reflecting actually the contents of editing/modifying operation onto the reversible code 42 in the processing starting from Step S15 in FIG. 8.

FIG. 10 illustrates a memory map in the memory of the client computer 7 in this case. In the memory space 51 in the memory 32 (RAM) of the client computer 7, the JPEG 2000 reversible code 42, the non-reversible image 52 which may be obtained from partially decoding the reversible code 42 as mentioned above with reference to FIG. 6A for example, and the above-mentioned instructions 44.

According to the above-described second specific example of processing, in case where processing of actually reflecting the contents of given editing/modifying operation on the reversible code 42 can be executed only by the printer 9 or it is preferable that processing of actually reflecting the contents of given editing/modifying operation on the reversible code 42 should be executed only by the printer 9 in terms of processing speed or so, it is possible that the relevant processing is made to be executed by the printer 9 instead of the client computer.

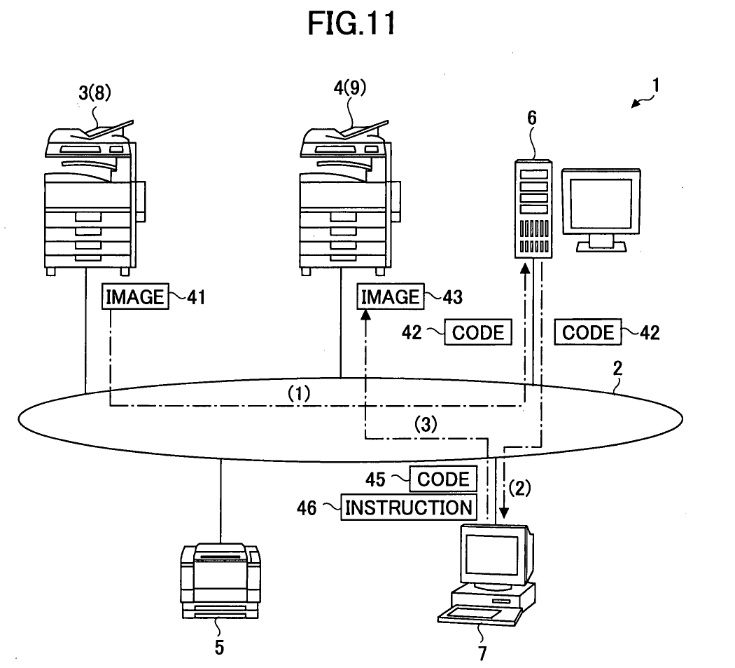

A third specific example of processing performed in the network system 1 according to the first embodiment of the present invention will now be described. FIG. 11 illustrates a data flow in the network system 1 in this case. Processing of arrows (1) and (2) is same as the processing of arrows (1) and (2) described above with reference to FIG. 4.

After that, it is determined whether the contents of editing/modifying operation given should be reflected onto the image in the form of reversible code 42 by the own apparatus (client computer 7) or by the printer 9, for each processing step of the contents of the relevant editing/modifying operation, in consideration of the processing contents to be reflected onto the image in the form of reversible code 42 the processing contents which should be actually performed on the image in the form of reversible code 42. Then, according to the determination result, when it is determined that the editing/modifying operation contents should be reflected on the reversible code 42 by the own apparatus, it is executed by the client computer 7 itself. On the other hand, when it is determined that the editing/modifying operation contents should be reflected on the reversible code 42 by the printer 9, it is executed by the printer 9 instead. In the latter case, the code 45 obtained already through some steps of the contents of given editing/modifying operation reflected by the client computer 7 itself or through no such steps, and instructions 46 indicating other steps of the contents of editing/modifying operation given determined to be reflected on the code 45 by the printer 9 are transmitted to the printer 9 in an arrow (3).

This determination of distributing between the client computer 7 and the printer 9 the reflectance job or the job of actually editing/modifying the reversible code may be made by the user of the client computer 7 with corresponding operation instructions given to the input device thereof manually, or may be determined automatically by the client computer itself. In the latter case, for example, after the user inputs the contents of editing/modifying operation to be reflected or actually performed on the reversible code 45 in the client computer 7, the client computer 7 automatically determines by itself in consideration of the actual processing contents of the editing/modifying reflectance operation, as to whether this job should be executed by its own or by the printer 9, and then, according to the determination result, the client computer 7 automatically executes the relevant operation of reflecting the given editing/modifying operation contents on the code 45 by itself or transmits the code 45 and the instructions 46 for causing the printer 9 to execute the relevant operation of reflecting the given editing/modifying operation contents on the code 45 instead.

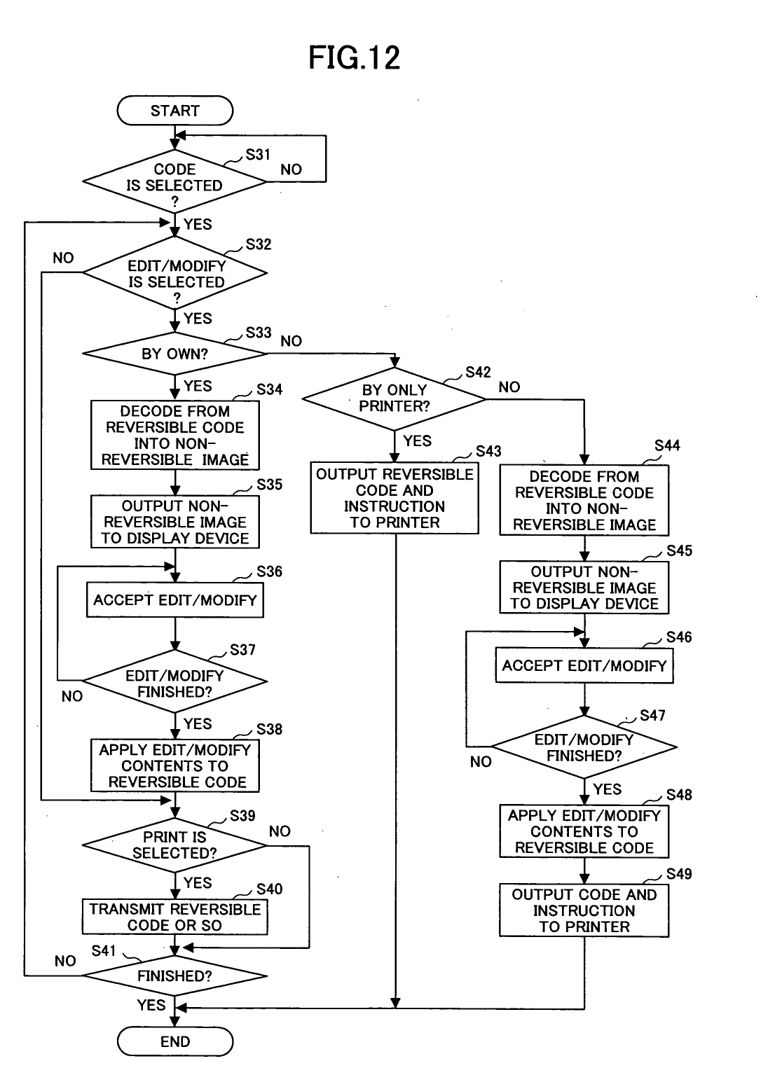

FIG. 12 shows an operation flow chart of processing performed by the client computer 7 acting as an image forming apparatus in this case. The processing is executed by the CPU 31 according to the image processing program same as the above. First, processing in Steps S31 and S32 same as the processing in Steps S1 and S2 described above with reference to FIG. 5 is performed.

After that, when the user inputs an editing/modifying operation to be reflected on the code 42 via the input device 35, it is determined whether or not this job of reflecting or actual performance of the thus-input contents of editing/modifying operation should be performed only by the own apparatus (client computer 7) in Step S33 (determining step). When it is determined that this job should be performed only by the own apparatus (Yes in Step S33), processing in Steps S34 through S41 is performed. This processing is same as the processing in Steps S3 through S10 described above with reference to FIG. 5. When it is determined that this job should not be performed only by the own apparatus (No in Step S33), it is then determined whether or not the relevant job should be performed only by the printer 9 instead in Step S42 (determining step). When it is determined that this job should be performed only by the printer 9 (Yes in Step S42), the relevant reversible code 42 in JPEG 2000 as well as instructions 44 which are information indicating the contents of the relevant editing/modifying operation is output to the printer 9 in Step S43. When it is determined that this job should be performed not only by the own apparatus (No in Step S33) nor only by the printer 9 (No in Step S42), that is, the reflectance processing or the actual performance of relevant editing/modifying operation should be executed by both the client computer 7 and the printer 9 in a load sharing manner, processing in Steps S44 through S49 is performed. Thereamong, the processing in Steps S44 through S48 is same as the processing in Steps S8 through S10 described above with reference to FIG. 5, while the processing in Step S49 is same as the processing in Step S43.

The above-mentioned determination processing in Steps S33 and S42 is executed based on a predetermined table in which executable contents (functions) of editing/modifying reflectance operation are listed up for each of the client computer 7 and the printer 9, and also, the priority order is set for each function which is executable by both the client computer 7 and the printer 9 as to which thereof should be selected with a priority for actually executing the relevant function. The printer 9 has a capability of executing many items of image editing/modifying operation by means of hardware, and thus, in many cases, the printer is superior to be charged in terms of processing speed. Accordingly, in such a case, the higher priority is given to the printer. Then, according to the table contents, the client computer 7 makes the relevant determination for each item of editing/modifying operation contents which the user inputs to reflect on the code 42 as to which of the apparatuses should be charged or whether both should be charged in a load shading manner.

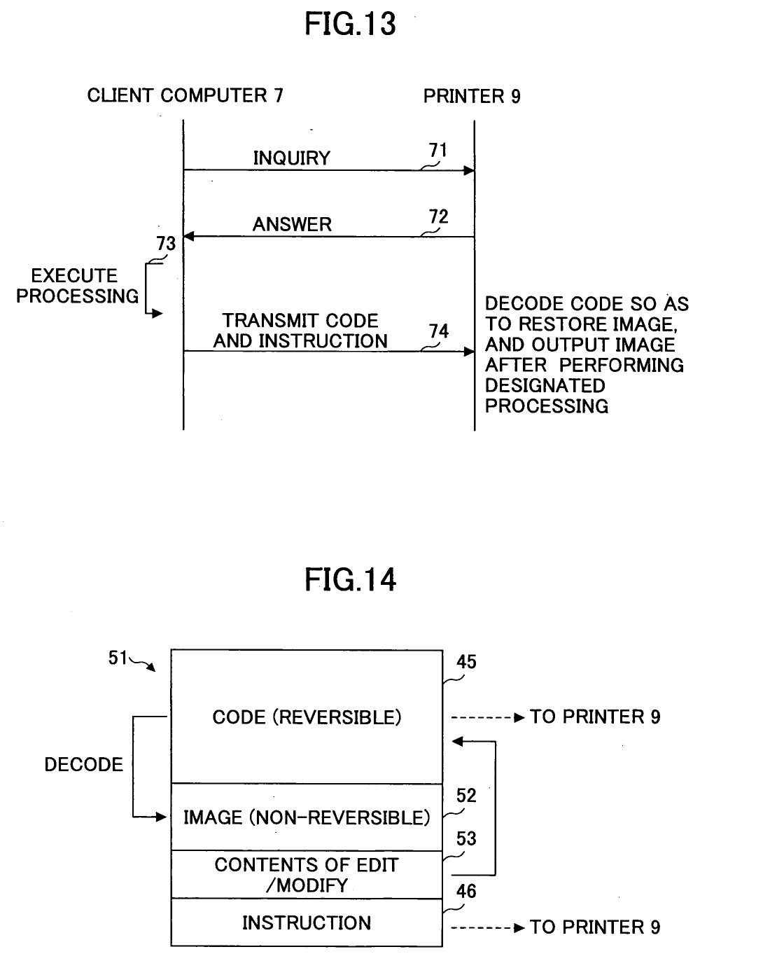

FIG. 13 shows a communication sequence illustrating specific communications performed between the client computer 7 and the printer 9 when Step S42 results in No. First, the client computer 7 inquires the printer 9 as to whether or not the printer 9 is of a type configured to execute the reflectance or actual performance of relevant editing/modifying operation in an arrow 71. After that, the printer 9 responds thereto, and the client computer 7 receives this response in an arrow 72. When the response indicates that the printer is of a type configured to execute the relevant reflectance operation, the client computer 7 determines for each item of the contents of relevant editing/modifying operation whether it should be executed by the own apparatus or by the printer 9. Then, the client computer 7 executes the relevant editing/modifying reflectance operation on the code 42 by itself for the relevant item which should be executed by itself according to the determination result, in response to the relevant input by the user in Steps S44 through S48 in an arrow 73. After that, the reversible code 45 in JPEG 2000 obtained through the above-mentioned processing is transmitted to the printer 9 together with instructions 46 indicating the remaining items of the contents of relevant editing/modifying operation given by the user on the client computer 7 in an arrow 74. In the printer 9, the code 45 received is decoded into the corresponding original image, which is then processed according to the instructions 46, i.e., the given editing/modifying operation contents are actually reflected on the image. In case where the result of Step S42 is Yes, the communication processing same as that described above with reference to FIG. 9 is performed.

FIG. 14 illustrates a memory map in the memory 32 (RAM) in the client computer 7 in this case. In the memory space 51 in the memory 32 of the client computer 7, the above-mentioned code 45 in JPEG 2000, the non-reversible image 52 obtained from partially decoding the code 45 for example for displaying on the display device, information 53 indicating the contents of the editing/modifying operation input by the user in Step S36 or S46 and the instructions 46 to be transmitted to the printer 9 as mentioned above are stored.

Thus, according to the specific example 3 of the processing, among relevant items of editing/modifying (reflectance) processing to be actually reflected or performed on the reversible code those which can be executed only by the client computer 7 or those which should be preferably executed by the client computer 7 can be executed by the client computer 7 itself, while those which can be executed only by the printer 9 or those which should be preferably executed by the printer 9 in terms of available processing speed or so can be made to be executed by the printer 9 instead.

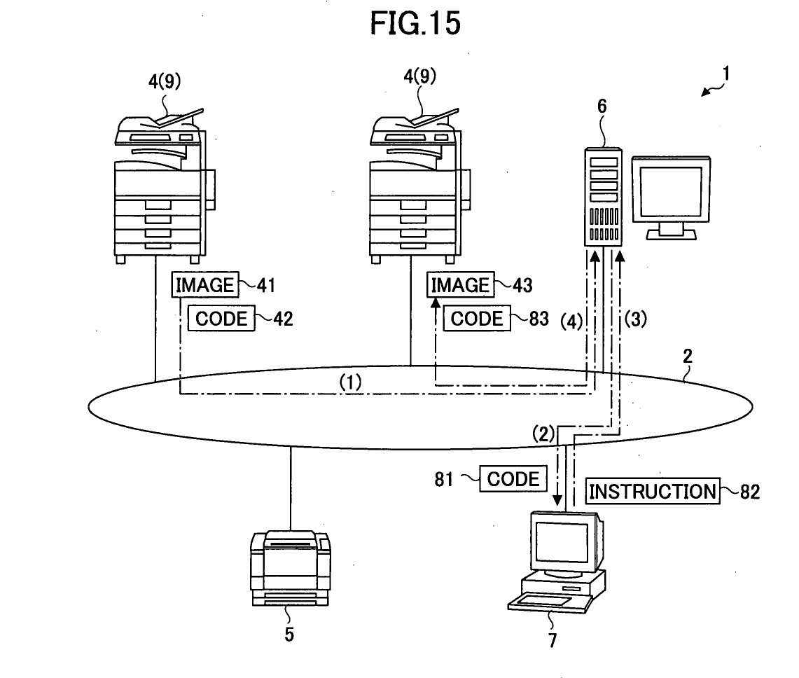

A specific example 4 of processing executed in the network system 1 in the first embodiment of the present invention will now be described. FIG. 15 illustrates a data flow in the network system 1 in this case. Processing of arrows (1) and (2) same as the processing of arrows (1) and (2) described above with reference to FIG. 4 is performed first.

After that, a user of the client computer 7 finds a desired image from among those stored in the server computer 6, and causes the image data to be transferred to the client computer 7. In this case, different from the above-described specific example 1, the client computer 7 brings a non-reversible code 81 obtained from a reversible code in JPEG 2000 stored in the server computer 6 (arrow (2)). As the non-reversible code 81 is brought instead of the reversible code in this example, the code amount, i.e., the size of data to be brought can be effectively reduced. As the code amount is reduced, it is possible to reduce a time required for transfer thereof accordingly. Furthermore, a required work area in the memory 32 (RAM) in the client computer 7 for handling the thus-brought non-reversible code 81 can also be reduced accordingly. As an example of such a non-reversible code 81, a code representing an image having the same size but having a reduced image quality, an image having the same image quality but having a reduced image size, an image having a reduced size and having a reduced image quality, or so according to JPEG 2000 may be applied.

Then, in the client computer 7, with a use of the thus-brought non-reversible code 81, a desired editing/modifying operation is performed. At this time, the user of the client computer 7 executes input of the editing/modifying operation with a use of the non-reversible code 81 displaying the corresponding image on the display device 36 therefrom, as if he/she executes the same operation onto the code 42 stored in the server computer 6. The contents of the thus-input editing/modifying operation are stored in the memory 32 (RAM). After the input operation, the same editing/modifying processing should be reflected on the reversible code 42 stored in the server computer 6, and for this purse, instructions 82 indicating the thus-stored contents of the input editing/modifying operation are transmitted to the server computer 6 in an arrow (3). The server computer 6 receiving the instructions 82 performs relevant processing of reflecting the contents of the ex-input editing/modifying operation on the original reversible code 42 according to the instructions 82. The code 83 thus obtained through the editing/modifying reflectance processing is then sent to the printer 9, from which the corresponding image 73 is then printed out, in an arrow (4). In this case, it is also possible that the server computer 6 causes the printer 6 to execute all of or a part of the above-mentioned editing/modifying reflectance processing for reflecting the contents of the editing/modifying operation input by the user from the client computer 7 as mentioned above, instead of the server computer 6 itself.

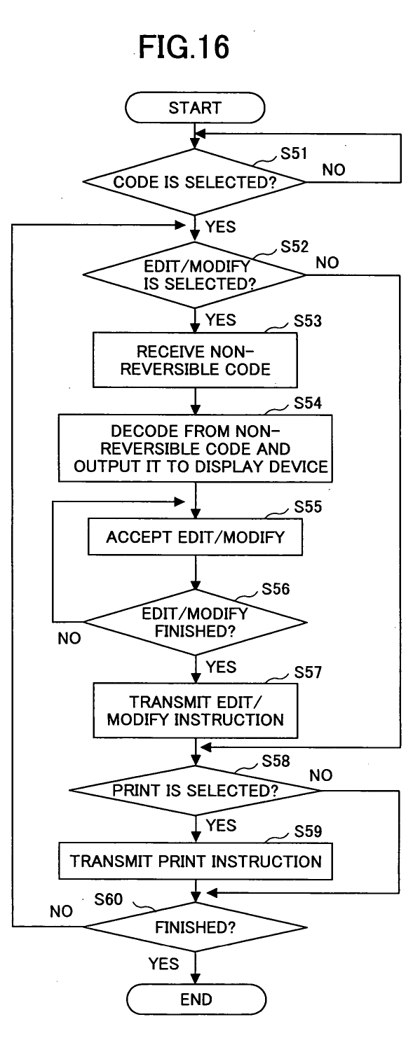

FIG. 16 shows an operation flow chart of processing executed by the client computer 6 in this case. This processing is executed by the CPU 31 based on the above-mentioned image processing program same as the above. First, when the user operates the client computer 7, selects the reversible code 42 stored in the magnetic storage device 34 of the server computer 6 (Yes in Step S51), and selects execution of editing/modifying of the code 42 (Yes in Step S52), the non-reversible code 81 produced from the code 42 is transmitted to the client computer 7 from the server computer 6. The thus-transmitted code 81 is received by the client computer 7 in Step S53, is decoded there, is output to the display device 36 in Step S54, and then, is displayed therewith.

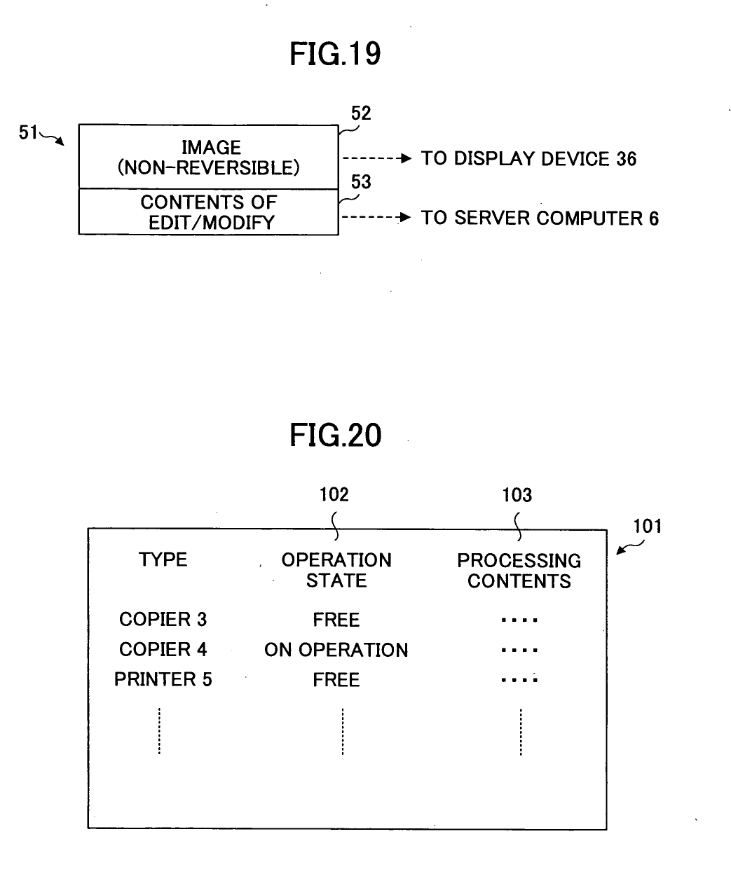

In Step S55, the user of the client computer 7 inputs editing/modifying operation to the client computer 7 with a use of the thus-displayed image, and the thus-input editing/modifying operation is accepted by the client computer 7. Information 53 (see FIG. 19) indicating the contents of the thus-input and accepted editing/modifying operation is stored in the memory 32 (RAM). When the processing of accepting the input editing/modifying operation is finished (Yes in Step S56), the client computer 7 transmits instructions 82 reflecting the information 53 indicating the contents of the input and accepted editing/modifying operation stored in the memory 32 as mentioned above, to the server computer 6 in Step S57.

When the user selects printing out of the code 42 after performing such input of editing/modifying operation or without performing such input operation (Yes in Step S58), the client computer 7 transmits instructions for printing out of the relevant code 42 to the server computer 6 in Step S59.

Then, when the user selects end of the series of processing via the input device 35 (Yes in Step S60), the processing is finished, while, in the other case the processing is returned to Step S52.

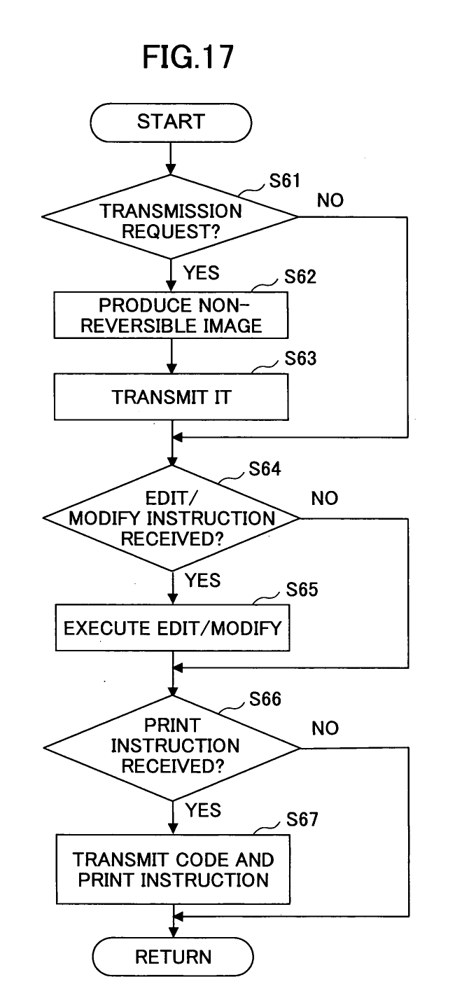

FIG. 17 shows a flow chart of processing executed by the server computer 6 acting as an image processing apparatus in this case. The system controller 16 in the server computer 6 receives the code 42 from the scanner 8, and stores it first (storing step). Then, when receiving a request for transmitting the code 42 with designation of this code from the client computer 7 (selecting step) (Yes in Step S61), the system controller 16 produces the non-reversible code 81 from the reversible code 42 (altering step) in Step S62, and transmits it to the client computer 7 according to the request in Step S63 (transmission step).

Then, when receiving the instructions 82 reflecting the information 53 concerning the input and accepted editing/modifying operation from the client computer 7 in Step S57 (Yes in Step S64), the system controller 16 in the server computer performs processing of reflecting the relevant editing/modifying processing (actual performance of the input editing/modifying) according to the instructions 82 (editing/modifying step) in Step S65.

When receiving the instructions of printing out of the code 42 transmitted from the client in Step S59 (Yes in Step S63), the system controller 16 in the server computer transmits the relevant designated code 42 after decoding or without decoding to the printer 9 together with the printing instructions in Step S64 (transmitting step). Thereby, the printer 9 is made to print out the relevant image.

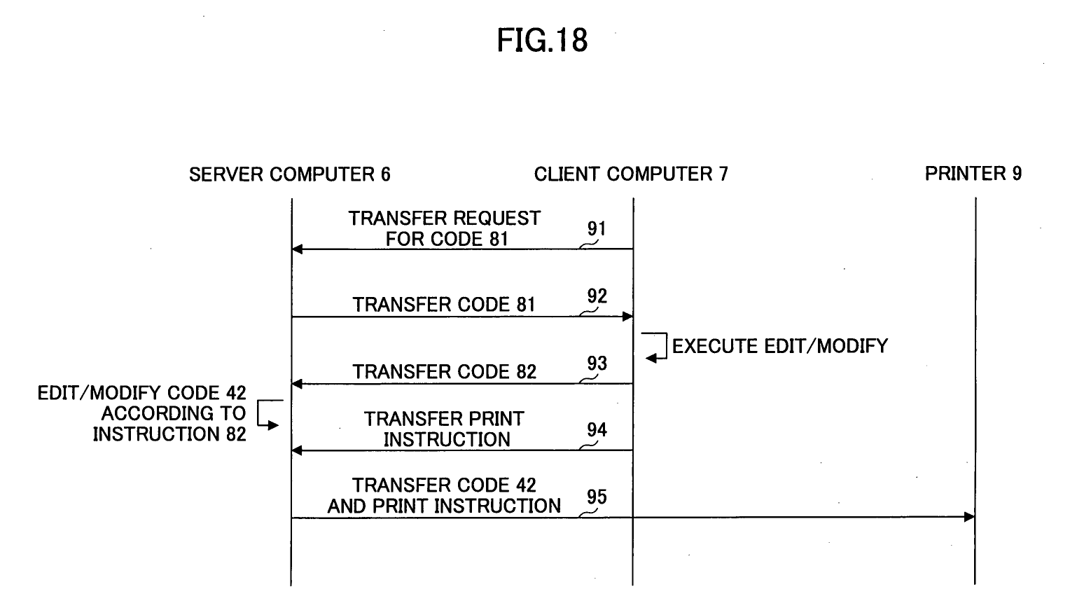

FIG. 18 shows a communication sequence of communications executed among the server computer 6, the client computer 7 and the printer 9 in this case. As described above, upon receiving the request given by the client computer 7 for causing the server computer 6 to transfer the non-reversible code 81 (arrow 91), the code 81 is transmitted to the client computer 7 in arrow 92. The client computer 7 accepts editing/modifying operation input by the user as mentioned above with a use of the code 81.

When the client computer 7 transfers the printing instructions to the server computer 6 in arrow 94, the code 42 (or image data obtained from decoding the code 42) and the printing instructions are transmitted to the printer 9 from the server computer 6 in arrow 95.

FIG. 19 illustrates a memory map in the memory 32 (RAM) in the client computer 7 in this case. In the memory space 51, the non-reversible image 52 used for displaying the relevant image on the display device 36, and the information 53 indicating the contents of editing/modifying operation input by the user on the client computer 7 based on the display of the image on the display device 36 as mentioned above are stored.

According to the specific example 4 of processing, as only the reduced size of the non-reversible code is transferred between the server computer 6 and the client computer 7 instead of the original reversible code (complete set of coded data), it is possible to effectively reduce the required data transfer amount therebetween. Also, in the server computer 6, input contents of editing/modifying operation are reflected on the reversible image, thus, the corresponding editing/modifying processing is performed on the reversible image which has the full image size and full image quality then. Accordingly, it is possible to achieve the network system 1 providing high image quality and high processing speed.

In each of the above-mentioned specific examples 2 through 4, it is possible to utilize a resource which is currently free of load in the network system 1, and thus, a load sharing processing may be achieved. In other words, a table such as that 101 shown in FIG. 20 is managed in the server computer 6, and relevant processing of reflecting a once input editing/modifying operation is made to be executed by a resource which is currently free of load.

This table is a table for registering, for each apparatus in the network system 1, an operation state 102 (whether the apparatus is under operation or free of job) and the contents of executable items of image editing/modifying processing 103. Then, in each of the specific examples 2 through 4, apparatuses which can execute relevant image editing/modifying processing are searched for from the table item 103, it is determined whether or not these apparatuses can be used currently, from the table item 102, and thus, load sharing processing for the relevant image editing/modifying processing is achieved in the network system 1. For the table item 102 for operation states of the respective apparatuses, the server computer 6 obtains the information by periodically inquiring of the respective apparatuses, and thus, the contents are updated. The table item 103 for the executable processing contents should be previously registered.

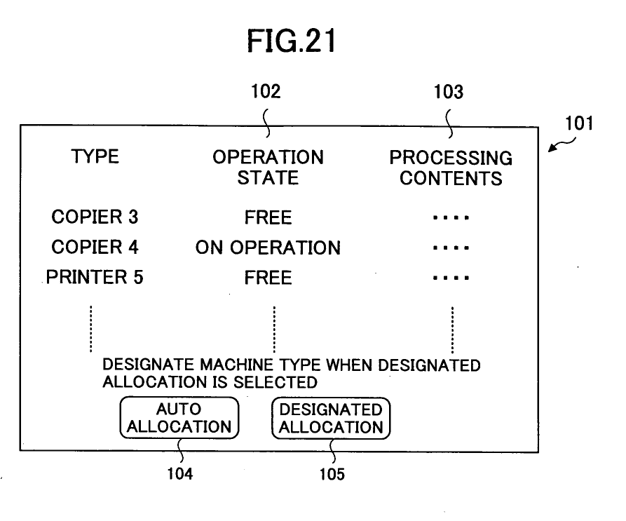

The client computer 7 can then refer to the contents of this table 101. Specifically, on the display device 36 in the client computer 7, as shown in FIG. 21, the contents of the table 101 are displayed on the screen. When a user of the client computer 7 may press an automatic allocation button 104 thereon, the server computer 6 executes allocation processing for achieving the above-described load sharing processing automatically. When the user presses a designated allocation button 105 thereon on the other hand, another operation page is displayed, and therewith, the user can select a type of apparatus to be actually applied. According to the selection by the user, the server computer 6 executes allocation processing for achieving the above-described load sharing processing automatically.

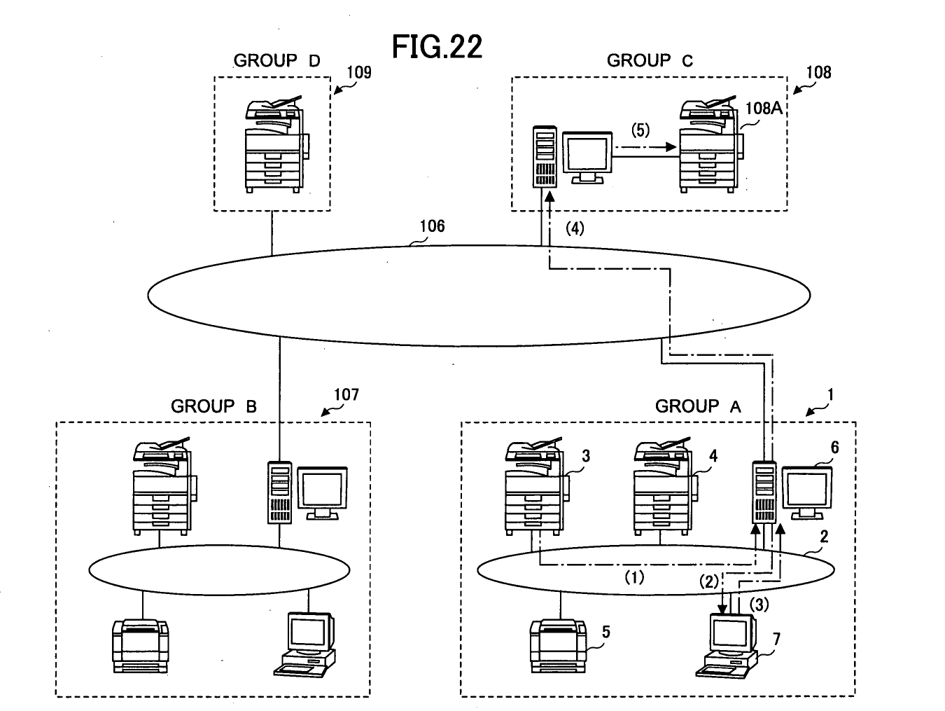

Furthermore, as shown in FIG. 22, in case where the above-mentioned network system 1 (Group A shown) is further connected with another network 106, it is also possible to also utilize apparatus resources connected with the network 106 other than those included in the network system 1. These apparatuses applicable may be apparatuses connected to another network 107 (Group B) connected to the network 106, apparatuses 108 (Group C) which is connected to the network 106 in a manner of one-to-one connection as shown, an apparatus 109 (Group D) connected with the network 106 alone, or so.

In a case where the above-described specific example 2 is applied to the specific example of FIG. 22, the above-mentioned processing of arrows (1) and (2) is performed in the same manner. However, when the client computer 7 outputs the code 42 and the instructions 44 to the server computer 6 in arrow (3), the server computer 6 in this case looks up the above-mentioned table 101, requests execution of the actual editing/modifying reflectance processing with the code 42 and instructions 44 of the apparatuses 108 in arrow (5) according to a determination based on the above-mentioned table contents 101, and a copier 108a of the apparatuses 108 may actually execute the relevant processing in arrow (5), as shown in FIG. 22, for example.

It is noted that, in each of the above-described specific examples, instead of transmitting a reversible code or a non-reversible code itself from one apparatus to another apparatus, a reversible or non-reversible image obtained from decoding the reversible or non-reversible code should be transmitted in case where the destination apparatus has not a function of decoding such a code.

A second embodiment of the present invention will now be described. A copier 111 according to the second embodiment has a hardware configuration same as the copier 3 or 4 described with reference to FIG. 2, same reference numerals are given here as those in the above-described first embodiment described with reference to FIGS. 2, and duplicated descriptions are omitted.

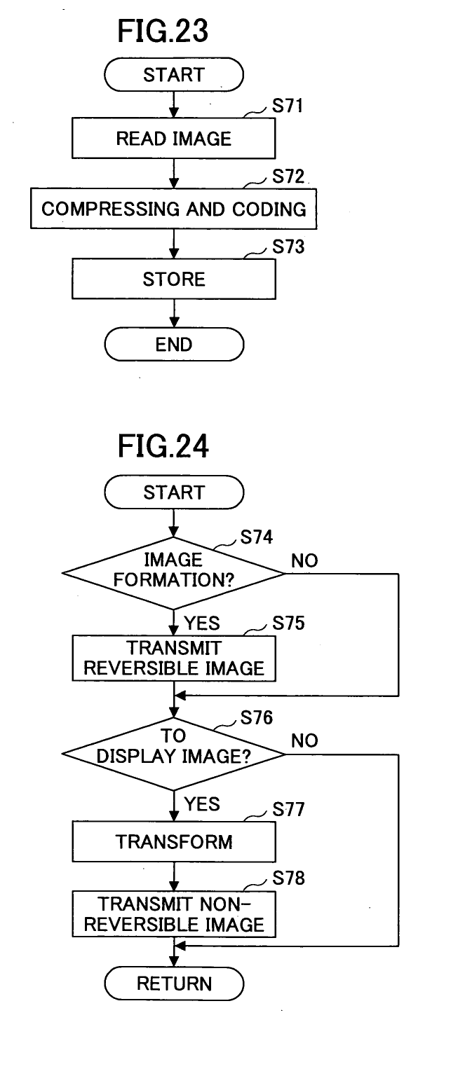

As the copier 111 also acts as an image forming apparatus according to the present invention, processing corresponding to the processing in the above-described specific example 1 is executed inside thereof. FIGS. 23 and 24 show flow charts of the processing. This processing is executed by a system controller 16 based on a control program stored in a ROM 16a acting as a storage medium. First, the system controller 16 causes a reading unit 11 to read an original image in Step S71, and the image 41 thus obtained is compressed and coded with a reversible mode in JPEG 2000 so that an image quality as high as possible is maintained in Step S72. The thus-obtained code is stored in a memory module 20 (storing step) in Step S73.

When the reversible code thus obtained from compressing and coding according to an algorithm of JPEG 2000 is processed by an IPP 15 for performing therein predetermined image processing or is used for printing out a corresponding image by the image forming unit 18 (selecting step) (Yes in Step S74), the system controller 16 transmits this code to a relevant device in the state of the reversible code or after decoding it into a reversible image via the MLC 26 (transmitting step) in Step S75.

On the other hand, when the image in the form of reversible code stored in the memory module is displayed on a liquid crystal device in an operation panel 24 or on a display device in an external personal computer (selection step) (Yes in Step S76), since not so high image quality is required for the purpose, the reversible code is once converted into a non-reversible code by the MLC 26 (altering step) in Step S77, is then decoded into image data, and then is transmitted to the relevant display device (transmitting step) in Step S78.

Thus, according to the second embodiment, since the non-reversible image is generated for the purpose of displaying on the operation panel 24 or so, and thus, the relevant processing is performed with the non-reversible image which has a reduced data size accordingly, it is possible to improve the data processing speed in the related transmission step or so. On the other hand, in a case of printing out by the image forming unit 18 or so where a high image quality is needed accordingly in general, the reversible image is used as it is. Thus, even a high image quality can be achieved in such a case.

Further, the present invention is not limited to the above-described embodiments, and variations and modifications may be made without departing from the claimed concepts of the present invention.

The present application is based on Japanese priority application No. 2003-066583 filed on Mar. 12, 2003, the entire contents of which are hereby incorporated by reference.

What is claimed is

1. An image processing system comprising a client apparatus connected with a communication network, wherein:
the client apparatus comprises:
a storing part storing a code which is obtained by reversibly compressing and coding an image according to a predetermined coding way having a hierarchy configuration from a reversible part through a non-reversible part;
an altering part generating, from the code, a non-reversible code;
a transmission part transmitting the either reversible or non-reversible code, or the image itself obtained from decoding the same code, to a predetermined transmission destination; and
a selecting part selectively performing transmission of the non-reversible code or the reversible code, or the image obtained therefrom.

2. The image processing system as claimed in claim 1, wherein:
the coding way comprises a method according to JPEG 2000.

3. The image processing system as claimed in claim 1, wherein:
said selecting part applies the image data in the form of non-reversible code when the data is displayed with a use of the code and therewith operation of editing or modifying is performed on the image data, while it applies the image data in the form of reversible code when it is transmitted to external apparatus via the communication network.

4. The image processing system as claimed in claim 1, wherein:
the selecting part transmits the reversible code having information indicating the contents of operation of editing or modifying the image data attached thereto.

5. The image processing system as claimed in claim 1, wherein:
the client apparatus comprises a determining part for determining whether the contents of operation of editing or modifying for the image data are actually reflected on the image data in the form of reversible code or the original image by the own apparatus or by another externally apparatus; and
the selecting part, when a determination is made by said determining part that the contents of operation of editing or modifying for the image data are actually reflected on the image data in the form of reversible code or the original image by another external apparatus, transmits the reversible code having information indicating the contents of operation of editing or modifying the image data attached thereto.

6. The image processing system as claimed in claim 1, further comprising a server apparatus which is also connected with the predetermined communication network,
wherein:
when receiving information indicating the contents of operation of editing or modifying the image data attached, the server apparatus performs processing of actually reflecting the contents of operation of editing or modifying on the image data in the form of reversible code or the original image according to the information thus received.

7. An image forming apparatus comprising:
a coding part reversibly compressing and coding an image according to a predetermined coding way having a hierarchy configuration from a reversible part through a non-reversible part;
a storing part storing the code;
a decoding part decoding the code;
a printer engine performing image formation on a medium based on the decoded image;
an altering part generating a non-reversible code from the code stored;
a transmission part transmitting the either reversible or non-reversible code, or the data of image obtained from decoding the code by said decoding part, to a predetermined transmission destination; and
a selecting part selectively performing transmission of the image data in the form of non-reversible code or in the form of reversible code thus generated, or the code itself.

8. The image forming apparatus as claimed in claim 7, wherein:
said selecting part transmits the image data in the form of reversible code when it is provided to the printer engine.

9. The image forming apparatus as claimed in claim 7, wherein:
said selecting part transmits the image data in the form of non-reversible code when it is used for displaying the image data on a display device of either another external apparatus or in the own apparatus for the purpose of performing an operation of editing or modifying the image data.

10. The image forming apparatus as claimed in claim 7, wherein:
said coding part applies a method according to JPEG 2000 for the predetermined coding way.

11. The image forming apparatus as claimed in claim 1, further comprising an image input device reading an original image, wherein:
said coding part performs the compression and coding on an image read in by said image input part.

12. A computer readable program causing a computer to perform:
a storing step of storing a code which is obtained by reversibly compressing and coding an image according to a predetermined coding way having a hierarchy configuration from a reversible part through a non-reversible part;
an altering step of generating, from the code, a non-reversible code;
a transmission step of transmitting the either reversible or non-reversible code, or the image obtained from decoding the code, to a predetermined transmission destination; and
a selecting step of selectively performing transmission of the non-reversible code or the reversible code, or the image obtained therefrom.

13. The computer readable program as claimed in claim 12, wherein:
in said selecting step, the image data in the form of reversible code is transmitted when it is provided for being used for printing processing.

14. The computer readable program as claimed in claim 12, wherein:
in said selecting step, the image data in the form of non-reversible code is transmitted when it is used for displaying the image data in a display device for the purpose of performing an operation of editing or modifying the image data.

15. The computer readable program as claimed in claim 12, wherein:
in said altering step, a method according to JPEG 2000 is applied for the predetermined coding way.

16. A computer readable information recording medium storing therein the program claimed in claim 12.

17. A computer readable information recording medium storing therein the program claimed in claim 13.

18. A computer readable information recording medium storing therein the program claimed in claim 14.

19. A computer readable information recording medium storing therein the program claimed in claim 15.

20. An image processing method comprising:
a storing step of storing a code which is obtained by reversibly compressing and coding an image according to a predetermined coding way having a hierarchy configuration from a reversible part through a non-reversible part;
an altering step of generating, from the code, a non-reversible code;
a transmission step of transmitting the either reversible or non-reversible code, or the image obtained from decoding the code, to a predetermined transmission destination; and
a selecting step of selectively performing transmission of the non-reversible code or the reversible code, or the image obtained therefrom.

21. The image processing method as claimed in claim 20, wherein:
in said selecting step, the image data in the form of reversible code is transmitted when it is provided for being used for printing processing.

22. The image processing method as claimed in claim 20, wherein:
in said selecting step, the image data in the form of non-reversible code is transmitted when it is used for displaying the image data in a display device for the purpose of performing an operation of editing or modifying the image data.

23. The image processing method as claimed in claim 20, wherein:
in said altering step, a method according to JPEG 2000 is applied for the predetermined coding way.

24. An image processing method using a client apparatus connected with a communication network, wherein:
the client performs:
a storing step of storing a code which is obtained by reversibly compressing and coding an image according to a predetermined coding way having a hierarchy configuration from a reversible part through a non-reversible part;
an altering step of generating, from the code, a non-reversible code;
a transmission step of transmitting the either reversible or non-reversible code, or the image obtained from decoding the code, to a predetermined transmission destination; and
a selecting step of selectively performing transmission of the non-reversible code or the reversible code, or the image obtained therefrom.

25. The image processing method as claimed in claim 24, wherein:
in said altering step, a method according to JPEG 2000 is applied for the predetermined coding way.

26. The image processing method as claimed in claim 24, wherein:
in said selecting step, the image data in the form of non-reversible code is performed when, in the client apparatus, the image data is displayed with a use of the generated code thus transmitted, and therewith, operation of editing or modifying is performed on the image data.

27. The image processing method as claimed in claim 24, wherein:
in said selecting step, the reversible code having information indicating the contents of operation of editing or modifying the image data attached thereto is transmitted.

28. The image processing method as claimed in claim 24, wherein:
the client apparatus performs a determining step of determining whether the contents of operation of editing or modifying for the image data are actually reflected on the image data in the form of reversible code or the original image by the own apparatus or by another externally apparatus; and
in the selecting step, when a determination is made in said determining step that the contents of operation of editing or modifying for the image data are actually reflected on the image data in the form of reversible code or the original image by another externally apparatus, the reversible code having information indicating the contents of operation of editing or modifying for the image data attached thereto is transmitted.

29. The image processing method as claimed in claim 24, wherein:
when information indicating the contents of operation of editing or modifying the image data is received in a server apparatus which is also connected with the predetermined communication network from the client apparatus, processing of actually reflecting the contents of operation of editing or modifying on the image data in the form of reversible code or the original image according to the information thus received is performed.
